(19) United States
(12) Patent Application Publication
(10) Pub. No.: US 2026/0074340 A1
(43) Pub. Date: Mar. 12, 2026

(54) SYSTEMS, DEVICES, AND METHODS FOR A WATERPROOF BATTERY CASE FOR A VEHICLE

(71) Applicant: Toyota Motor Engineering & Manufacturing North America, Inc., Plano, TX (US)

(72) Inventors: Christopher N. Wimsatt, Finchville, KY (US); Alexander P. Remsburg, Whitmore Lake, MI (US); Glen R. Gnadinger, Lexington, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/830,407

(22) Filed: Sep. 10, 2024

(51) Int. Cl. H01M 50/24; H01M 50/249

(52) U.S. Cl. CPC H01M 50/24; H01M 50/249

(57) ABSTRACT

Systems, devices, and methods for a waterproof case for sealing and protecting a vehicle battery. The case may include a frame formed in the shape of a rectangle and defining a cavity for holding a vehicle battery. The frame may include a plurality of side beams each having one or more cavities having a first width and a first height. The frame may further include a plurality of end beams each having a plurality of protrusions. The plurality of protrusions may each have a greater width than the first width and a greater height than the first height. The plurality of protrusions may be configured to be inserted into the one or more cavities to align the plurality of side beams with the plurality of end beams. The case may further include a plurality of covers configured to sandwich and seal the frame to prevent water from entering the cavity.

### BACKGROUND

### 1. Field

The present disclosure relates to systems, devices, and/or methods for a waterproof battery case for a vehicle.

### 2. Description of the Related Art

Certain vehicles, such as battery electric vehicles (BEVs) and/or hybrid electric vehicles (HEVs), may include a battery housed within a battery case. Generally, the battery case is meant to (among other things) house and protect the battery from water, for example. However, current battery cases often fail to protect the battery from water. For example, water may leak into current battery cases through gaps that are present from the date of manufacture of a vehicle and/or that form after a period of use of the vehicle (e.g., due to cracks forming in welds of the current battery cases). The generally high cost of BEV and/or HEV batteries means that a battery case that fails by allowing water to leak into the battery case and damage the battery may result in costly repairs.

Accordingly, it is desirable to provide systems, devices, and methods for a waterproof battery case for a vehicle.

### SUMMARY

In general, one aspect of the subject matter described in this disclosure may be embodied in a waterproof case for sealing and protecting a vehicle battery. The waterproof case may include a frame formed in the shape of a rectangle and defining a cavity for holding at least one vehicle battery. The frame may include a plurality of side beams. The plurality of side beams may include a front side beam and a rear side beam. The plurality of side beams may each have a left end and a right end. The plurality of side beams may each further have one or more cavities. The one or more cavities may have a first width and a first height. The frame may further include a plurality of end beams. The plurality of end beams may each have a front end, a rear end, and a plurality of protrusions. The plurality of protrusions may include a front protrusion. The front protrusion may have a greater width than the first width and a greater height than the first height. The front protrusion may be configured to be inserted into the one or more cavities of the front side beam from the left end of the front side beam or the right end of the front side beam to align the front side beam with the plurality of end beams. The plurality of protrusions may further include a rear protrusion. The rear protrusion may have a greater width than the first width and a greater height than the first height. The rear protrusion may be configured to be inserted into the one or more cavities of the rear side beam from the left end of the rear side beam or the right end of the rear side beam to align the rear side beam with the plurality of end beams. The waterproof case may further include a plurality of covers including a top cover and a bottom cover. The plurality of covers may be configured to sandwich and seal the frame to prevent water from entering the cavity.

In one aspect, the subject matter may be embodied in a waterproof battery case for housing and protecting a vehicle battery. The waterproof battery case may include a plurality of covers. The waterproof battery case may further include a frame sandwiched between the plurality of covers. The frame may define a cavity for holding at least one vehicle battery. The frame may include a plurality of extruded case sides. The plurality of extruded case sides may each have a wall defining one or more cavities. The frame may further include a plurality of cast case ends. The plurality of cast case ends may be configured to couple to the plurality of extruded case sides. The plurality of cast case ends may each have a plurality of protrusions. The plurality of protrusions may be configured to be inserted into the one or more cavities. The plurality of protrusions may be further configured to swell and/or deform the wall to align the plurality of extruded case sides relative to the plurality of cast case ends when the plurality of protrusions are inserted into the one or more cavities.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a schematic of an example vehicle with which an example battery case may be implemented according to an aspect of the disclosure.

FIG. 2 is an exploded view of the example battery case of FIG. 1 according to an aspect of the disclosure.

FIG. 3 is a cross-sectional view of an example case side of one or more case sides according to an aspect of the disclosure.

FIG. 4 is a perspective view of the example battery case of FIG. 1 without a top cover according to an aspect of the disclosure.

FIG. 5 is a perspective view of an outer protrusion of one or more outer protrusions according to an aspect of the disclosure.

FIG. 6 is a cross-sectional view of a portion of the example battery case of FIG. 4 according to an aspect of the disclosure.

FIG. 7 is a perspective view illustrating an example manufacturing step for the example battery case of FIG. 1 according to an aspect of the disclosure.

FIG. 8 is a perspective view illustrating a subsequent example manufacturing step for the example battery case of FIG. 1 according to an aspect of the disclosure.

### DETAILED DESCRIPTION

Disclosed herein are systems, devices, vehicles, and/or methods for implementing a battery case for a vehicle. The battery case may include one or more covers coupled to a frame. The frame may include one or more case ends and one or more case sides. Each of the one or more case ends may include one or more protrusions that are configured to be inserted into ends of the one or more case sides. Particular embodiments of the subject matter described in this disclosure may be implemented to realize one or more of the following advantages.

The one or more protrusions may locate and/or align the one or more case sides relative to the one or more case ends when the one or more protrusions are inserted into the one or more case sides. This may improve sealing of the battery case by having the one or more case sides be flush with a surface of the one or more case ends and/or a surface of the one or more covers thereby reducing or eliminating any gaps within the battery case. This may also improve the quality and/or the ease of welding a plurality of joints formed between the one or more case sides and the one or more case ends (which may also improve the sealing of the battery case).

Moreover, the one or more protrusions may strengthen the plurality of joints formed between the one or more case sides and the one or more case ends. This may ensure that the battery case remains sealed by preventing gaps and/or cracks from forming within the battery case (e.g., the one or more protrusions may prevent welds of the battery case from cracking).

Moreover, the battery case may have a lower manufacturing cost compared to current battery cases. For example, the one or more case sides may be formed by extruding a first material (e.g., aluminum, steel, etc.) and the one or more case ends may be formed by casting a second material (e.g., aluminum, steel, etc.). The one or more case ends may require minimal to no tooling after being cast. In addition, since the one or more protrusions locate and/or align the one or more case sides relative to the one or more case ends, the battery case may require less fixturing during the manufacture of the battery case. Thus, the battery case may improve the ease of manufacture (thereby reducing cost) compared to current battery cases and while having improved sealing compared to current battery cases.

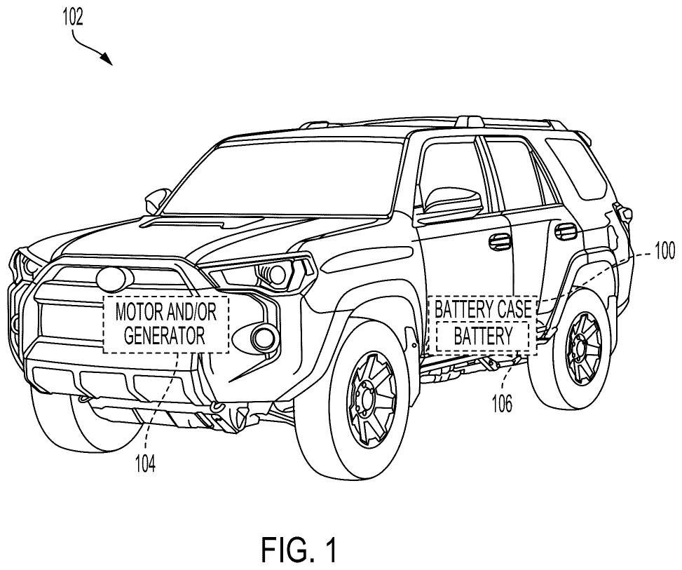

FIG. 1 illustrates an example vehicle 102 in which an example battery case 100 (also may be referred to as a waterproof case 100) may be implemented. The battery case 100 may be retrofitted, coupled to, include, or be included within the vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The vehicle 102 may include a motor and/or generator 104 and a battery 106. The motor and/or generator 104 may be located within an engine bay of the vehicle 102. In examples, the motor and/or generator 104 may be located at and/or adjacent to one or more axles of the vehicle 102 such that the vehicle 102 includes one motor and/or generator 104 or a plurality of motors and/or generators. The motor and/or generator 104 may be an internal combustion engine (ICE). In this regard, the motor and/or generator 104 may combust an air and fuel mixture to provide power to the vehicle 102 and/or components of the vehicle 102. Accordingly, the motor and/or generator 104 can cause the vehicle 102 to accelerate, decelerate, or maintain a desired velocity. The motor and/or generator 104 may include combinations of an ICE and an electric motor, such as for hybrid electric vehicle (HEV) applications, for example. In examples, the motor and/or generator 104 may be an electric motor, such as for battery electric vehicle (BEV) applications, for example. In this regard, the motor and/or generator 104 may be an electric motor and/or an electric generator that converts electrical energy into mechanical power, such as torque, and converts mechanical power into electrical energy. The motor and/or generator 104 may be electrically connected to the battery 106. The motor and/or generator 104 may convert energy from the battery 106 into mechanical power, and may provide energy back to the battery 106, for example, via regenerative braking.

The battery 106 may be retrofitted, coupled to, include or be included within the vehicle 102. The battery 106 may be electrically connected to the motor and/or generator 104 and/or other components of the vehicle 102. The battery 106 may store chemical energy for later conversion to electrical energy. The battery 106 may provide the electrical energy to and/or receive electrical energy from the motor and/or generator 104 and/or other components of the vehicle 102. The battery 106 may be a battery pack that includes one or more battery modules and/or a power management system (BMS). The one or more battery modules may each include one or more cells. The one or more cells may be cylindrical cells, prismatic cells, and/or pouch cells (in examples, other types of cells may be used). A chemistry of the one or more cells may be lithium ion (Li-Ion), nickel manganese cobalt (NMC), nickel metal hydride (Ni—MH), lithium sulfur (Li—S), and/or lead-acid (in examples, other chemistries may be used).

In examples, the vehicle 102 may include a plurality of batteries and/or a plurality of battery cases. The battery case 100 may be coupled to a chassis and/or a body of the vehicle 102. The battery case 100 may be positioned at, along, and/or proximate to an undercarriage of the vehicle 102, for example. In examples, the battery case 100 may be positioned underneath a bed floor of the vehicle 102 (e.g., in instances where the vehicle 102 is a pickup truck) and/or other locations within or on top of the vehicle 102 (e.g., underneath a hood of the vehicle 102, on top of a roof of the vehicle 102, within a trunk of the vehicle 102, etc.). The battery case 100 may be configured to house and/or protect the battery 106. The battery case 100 may further house or include electrical components (e.g., electrical connectors and/or wires) configured to electrically couple the battery 106 to the vehicle 102. The battery case 100 may protect the battery 106 from physical damage, heat, cold, water, and/or moisture, for example. The battery case 100 may be waterproof. Moreover, the battery case 100 may provide structural support for the battery 106 and/or may couple the battery 106 to the vehicle 102.

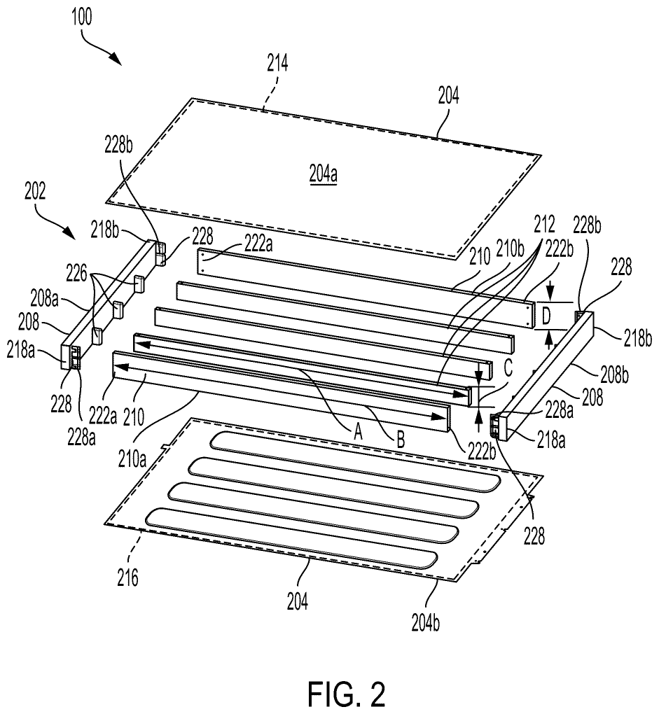

FIG. 2 is an exploded view of the battery case 100. Referring to FIG. 2 with continuing reference to FIG. 1, the battery case 100 may include one or more covers 204 and a frame 202. The one or more covers 204 may include a top (or first) cover (or plate) 204a and/or a bottom (or second) cover (or plate) 204b. The one or more covers 204 may be coupled to the frame 202 to form the battery case 100. For example, the top cover 204a and the bottom cover 204b may sandwich the frame 202 to cover and seal the frame 202. The one or more covers 204 may be coupled to the frame 202 such that the battery case 100 is hermetically sealed and/or waterproof. For example, the one or more covers 204 may be coupled, welded, and/or bonded to the frame 202 through the use of heat, a bonding agent, a gasket, a sealant, an adhesive, and/or one or more fasteners (e.g., bolts, screws, rivets, etc.) along a perimeter 214 of the top cover 204a and/or a perimeter 216 of the bottom cover 204b. The one or more covers 204 may be made of a material having high thermal conductivity and/or rigidity, such as aluminum (in examples the one or more covers 204 may be made of steel and/or other metals, alloys, and/or composites).

When the one or more covers 204 are coupled to the frame 202 to form the battery case 100, at least one or all of the one or more covers 204 may be removable from the frame 202 (e.g., to inspect, service, and/or remove the battery 106). In examples, the one or more covers 204 may not be removable from the frame 202 (e.g., the battery case 100 and the battery 106 may be a unit that is replaced together and/or the battery case 100 may require being cut open to remove the battery 106).

In examples, the top cover 204a may define and/or be positioned along a first horizontal plane and/or the bottom cover 204b may define and/or be positioned along a second horizontal plane. The first horizontal plane may be parallel to the second horizontal plane such that the top cover 204a is parallel to the bottom cover 204b when the one or more covers 204 are coupled to the frame 202.

The frame 202 may have a rectangular shape as shown in FIG. 2 (in examples, the frame 202 may have a square or other shape). The frame 202 may form four walls (or sides) of the battery case 100. The frame 202 may define a cavity for holding at least one vehicle battery (e.g., the battery 106). The frame 202 may include one or more case sides (or side beams) 210, one or more internal bars (or beams) 212, and/or one or more case ends (or end beams) 208. The one or more case sides 210 may include two case sides as shown in FIG. 2 (in examples, the one or more case sides 210 may include one case side). For example, the one or more case sides 210 may include a front case side 210a and a rear case side 210b. As shown in FIG. 2, the one or more case sides 210 may form two walls (or sides) of the frame 202 and/or the battery case 100. The one or more case sides 210 may be positioned between the one or more case ends 208. Moreover, the one or more case sides 210 may be configured to couple to the one or more case ends 208 to form four walls of the frame 202 and/or the battery case 100. The one or more case sides 210 may each have a left (or first) end 222a and a right (or second) end 222b opposite the left end 222a defining a length B of the one or more case sides 210.

The one or more case sides 210 may be formed by extruding a material, such as aluminum or steel (in examples the one or more case sides 210 may be made of different metals, plastics, and/or composites and/or by different processes). By being extruded, the one or more case sides 210 may have a lower manufacturing cost and/or increased ductility compared to other manufacturing processes, such as casting and/or CNC machining, for example. The one or more case sides 210 may be in the shape of rectangular tubes (in examples, the one or more case sides 210 may be in the shape of square tubes or other tubes with a different shape).

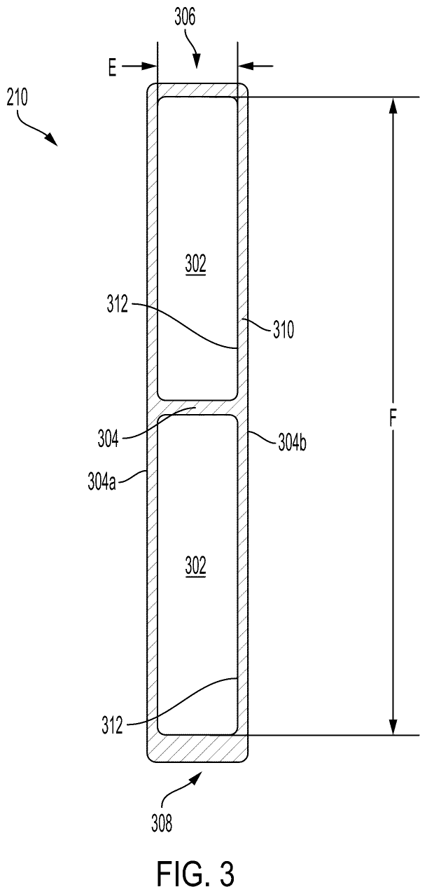

Referring briefly to FIG. 3, a cross section of a case side (e.g., the front case side 210a or the rear case side 210b) of the one or more case sides 210 is shown. The one or more case sides 210 may each have one or more cavities 302 that span the length B of the one or more case sides 210. As shown in FIG. 3, the one or more case sides 210 may each have two cavities and a support piece 304 that reinforces the one or more case sides 210. The support piece 304 may increase the strength and/or the stiffness of the one or more case sides 210, for example. The support piece 304 may span from a first side 304a of the one or more case sides 210 to a second side 304b of the one or more case sides 210 to divide an internal volume of the one or more case sides 210 into the two cavities 302. In examples, the one or more case sides 210 may not have the support piece 304 and may have one cavity. In other examples, the one or more case sides 210 may have a plurality of support pieces and more than two cavities.

The one or more case sides 210 may each have a wall 310. The wall 310 may include the support piece 304. The wall 310 may define the one or more cavities 302 and an inner surface 312 of the one or more case sides 210. The wall 310 may have a top (or first) portion (or end) 306 and a bottom (or second) portion (or end) 308 that is opposite the top portion 306. As shown in FIG. 3, the wall 310 may have a nonuniform thickness with the top portion 306 being thinner than the bottom portion 308 of the wall 310. This may reduce a weight of the one or more case sides 210 while still maintaining the strength and stiffness of the one or more case sides 210 (e.g., by having more material in areas that may see more stress). In examples, the wall 310 may have a uniform or substantially uniform thickness.

Referring again to FIG. 2, the one or more internal bars 212 may be positioned between the one or more case ends 208 and/or within the battery case 100. The one or more internal bars 212 may be positioned equidistant from each other within the battery case 100. Moreover, the one or more internal bars 212 may be configured to couple to the one or more case ends 208. In addition, the one or more internal bars 212 may be configured to increase the strength and/or the stiffness of the frame 202 and/or the battery case 100. The one or more internal bars 212 may include three internal bars as shown in FIG. 2 (in examples, the one or more internal bars 212 may include one internal bar or more than three internal bars).

The one or more internal bars 212 may be formed by extruding a material, such as aluminum or steel (in examples the one or more internal bars 212 may be made of different metals, plastics, and/or composites and/or by different processes). By being extruded, the one or more internal bars 212 may have a lower manufacturing cost and/or increased ductility compared to other manufacturing processes, such as casting and/or CNC machining, for example. The one or more internal bars 212 may be in the shape of rectangular tubes (in examples, the one or more internal bars 212 may be in the shape of square tubes or other tubes with a different shape). In examples, the one or more internal bars 212 may be solid for all or substantially all of a length A of the one or more internal bars 212.

The length A of the one or more internal bars 212 may be the same or substantially the same as the length B of the one or more case sides 210. Moreover, the one or more internal bars 212 may have a height C that is less than a height D of the one or more case sides 210 to allow for more space for the battery 106 within the battery case 100 (in examples, the height C may be the same as the height D for increased strength and/or stiffness of the frame 202 and/or the battery case 100).

The one or more case ends 208 may include a left (or first) case end 208a and a right (or second) case end 208b (in examples, the one or more case ends 208 may include one case end). The one or more case ends 208 may form two ends (or walls) of the frame 202 and/or the battery case 100. For example, the left case end 208a may form a left end (or wall) of the frame 202 and/or the battery case 100 and the right case end 208b may form a right end (or wall) of the frame 202 and/or the battery case 100, with the right case end 208b being opposite the left case end 208a and defining a width (or length) of the frame 202 and/or the battery case 100. The one or more case ends 208 may each have a front (or first) end 218a and a rear (or second) end 218b opposite the front end 218a defining a length of the one or more case ends 208 and/or a depth of the frame 202 and/or the battery case 100.

The one or more case ends 208 may be formed by casting and/or CNC machining a material, such as aluminum or steel (in examples, the one or more case ends 208 may be made of different metals and/or by different processes). For example, a casting may be produced and then machined with a CNC machine to form the one or more case ends 208 (in examples, a casting may form the one or more case ends 208 without being machined). The one or more case ends 208 may be in the shape of a rectangular bar (or beam) (in examples the one or more case ends 208 may be in the shape of a square bar or a different elongate shape). The right case end 208b may be a duplicate of the left case end 208a. In examples, the right case end 208b may have a different shape and/or features than the left case end 208a and/or may be a mirrored version of the left case end 208a.

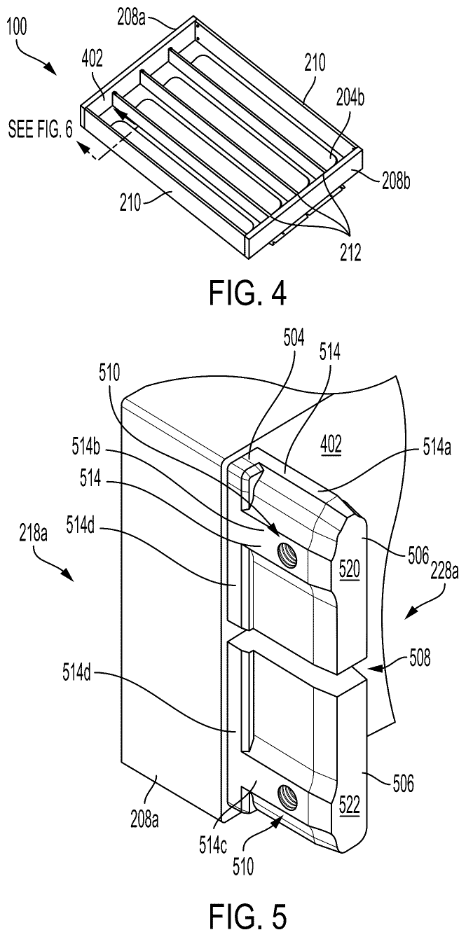

The one or more case ends 208 may each have one or more inner (or first) protrusions 226 and/or one or more outer (or second) protrusions 228. As shown in FIG. 2, each of the one or more case ends 208 may include three inner protrusions (in examples, each case end may include one inner protrusion, two inner protrusions, or more than three inner protrusions). The one or more inner protrusions 226 may protrude from an inner surface 402 (marked in FIGS. 4 and 5) of the one or more case ends 208, with the inner surface 402 facing toward an interior of the frame 202 and/or the battery case 100. That is, the one or more inner protrusions 226 may protrude from the inner surface 402 of the one or more case ends 208 toward the interior of the frame 202 and/or the battery case 100. The one or more inner protrusions 226 may be perpendicular to a length-wise axis of the one or more case ends 208 and/or the inner surface 402 of the one or more case ends 208.

As discussed above, the one or more internal bars 212 may be configured to couple to the one or more case ends 208. The one or more inner protrusions 226 of each of the one or more case ends 208 may be configured to be inserted into a respective end of the one or more internal bars 212 to couple the one or more internal bars 212 to the one or more case ends 208 (as shown in FIG. 4). When the one or more inner protrusions 226 are inserted into the ends of the one or more internal bars 212, one or more fasteners (e.g., a pin, a screw, a bolt, etc.) may be used to further couple and/or secure the one or more internal bars 212 to the one or more case ends 208. In addition or alternatively, when the one or more inner protrusions 226 are inserted into the ends of the one or more internal bars 212, the ends of the one or more internal bars 212 may be welded to the one or more case ends 208 to further couple and/or secure the one or more internal bars 212 to the one or more case ends 208.

As shown in FIG. 2, each of the one or more case ends 208 may include two outer protrusions (in examples, each case end may include one outer protrusion or more than two outer protrusions). For example, a front (or first) outer protrusion 228a may be positioned at the front end 218a of each of the one or more case ends 208 and a rear (or second) outer protrusion 228b may be positioned at the rear end 218b of each of the one or more case ends 208 as shown in FIG. 2. The one or more outer protrusions 228 may protrude from the inner surface 402 (marked in FIGS. 4 and 5) of the one or more case ends 208. The one or more outer protrusions 228 may be perpendicular to the length-wise axis of the one or more case ends 208 and/or the inner surface 402 of the one or more case ends 208.

The one or more outer protrusions 228 of each of the one or more case ends 208 may be configured to be inserted into a respective end (e.g., the left end 222a or the right end 222b) of the one or more case sides 210 to couple the one or more case sides 210 to the one or more case ends 208 as shown in FIG. 4. FIG. 4 illustrates the battery case 100 without the top cover 204a to better illustrate the one or more case ends 208 coupled to the one or more case sides 210 and the one or more internal bars 212 forming the frame 202.

FIG. 5 is an enlarged view of the front outer protrusion 228a of the left case end 208a of FIG. 2. Referring to FIG. 5 with continuing reference to FIGS. 2 and 3, the features of the front outer protrusion 228a of the left case end 208a may be applicable to each of the one or more outer protrusions 228. For example, the front outer protrusion 228a may be the same as the rear outer protrusion 228b except that the front outer protrusion 228a may be a mirrored version of the rear outer protrusion 228b, in examples.

Each of the one or more outer protrusions 228 may have a distal end 506 and a proximal end 504. As shown in FIG. 5, the distal end 506 may be tapered (e.g., to improve the ease of inserting the one or more outer protrusions 228 into a respective end (e.g., the left end 222a or the right end 222b) of the one or more case sides 210).

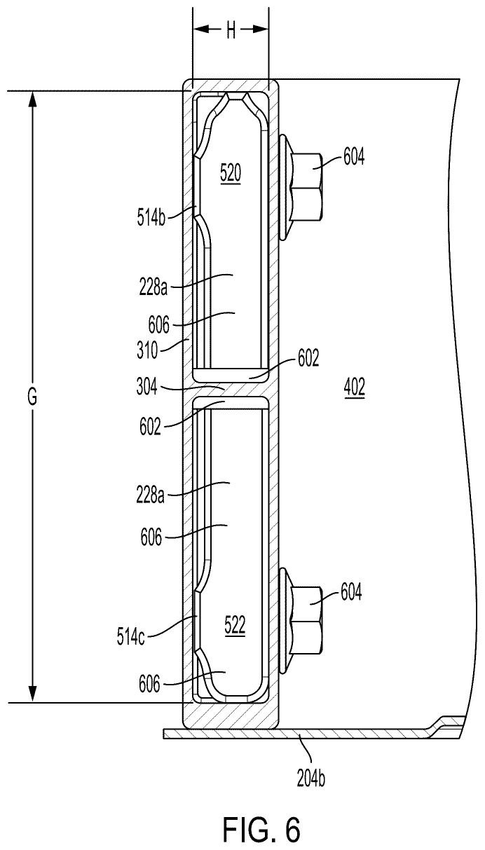

In examples, each of the one or more outer protrusions 228 may further include a slot (or cutout) 508. The slot 508 may divide the one or more outer protrusions 228 into two portions. For example, the slot 508 may divide the one or more outer protrusions 228 into a top (or first) portion 520 and a bottom (or second) portion 522. When the one or more outer protrusions 228 are inserted into a respective end (e.g., the left end 222a or the right end 222b) of the one or more case sides 210, the slot 508 may receive the support piece 304 (marked in FIG. 3 and FIG. 6).

FIG. 6 is a cross section of a portion of FIG. 4 illustrating the front outer protrusion 228a of the left case end 208a inserted into the left end 222a of the front case side 210a of the one or more case sides 210. Referring to FIGS. 5 and 6 with continuing reference to FIG. 2, when the one or more outer protrusions 228 are inserted into a respective end (e.g., the left end 222a or the right end 222b) of the one or more case sides 210, a gap 602 may be formed between the support piece 304 and the top portion 520 and/or the bottom portion 522 of the one or more outer protrusions 228. The slot 508 may be configured to form the gap 602 to allow for a broader range of tolerances for the dimensions of the one or more outer protrusions 228 and/or the support piece 304.

Moreover, each of the one or more outer protrusions 228 may further include one or more raised surfaces (or portions) 514. The one or more raised surfaces 514 may engage and/or deform the inner surface 312 (marked in FIG. 3) and the wall 310 of the one or more case sides 210 when the one or more outer protrusions 228 are inserted into a respective end (e.g., the left end 222a or the right end 222b) of the one or more case sides 210. In examples, the one or more raised surfaces 514 may cause a respective end (e.g., the left end 222a or the right end 222b) of the one or more case sides 210 to enlarge (or swell) when the one or more outer protrusions 228 are inserted into the respective end of the one or more case sides 210.

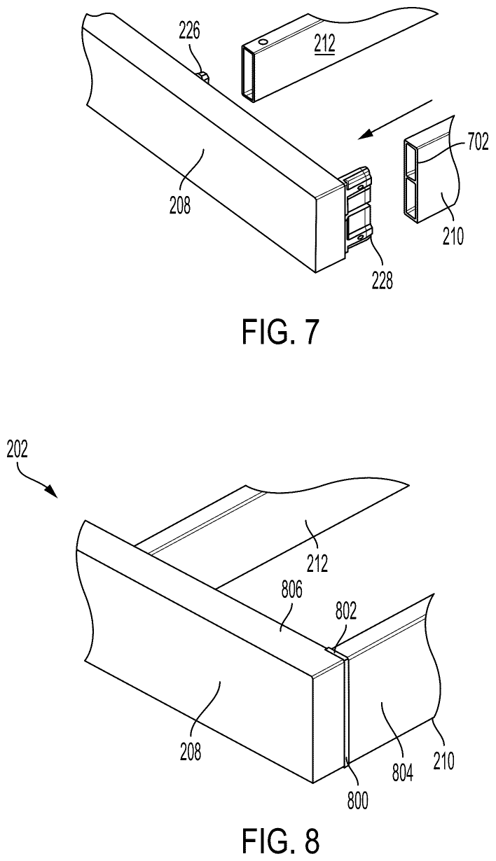

By engaging and/or deforming the inner surface 312 and the wall 310 of the one or more case sides 210, the one or more raised surfaces 514 may mechanically locate and/or align the one or more case sides 210 relative to the one or more case ends 208. This may lessen or eliminate any gaps between the one or more case sides 210 and the one or more case ends 208 and/or between the frame 202 and the top cover 204a and/or the bottom cover 204b thereby improving sealing of the battery case 100. For example, the one or more raised surfaces 514 may cause an outer surface 702 (marked in FIG. 7) of the ends 222a and 222b of the one or more case sides 210 to sit flush against the one or more case ends 208 (e.g., flush against the inner surface 402). In addition, the one or more raised surfaces 514 may cause a bottom surface of the one or more case sides 210 to be coplanar with a bottom surface of the one or more case ends 208. Moreover, by locating and/or aligning the one or more case sides 210 relative to the one or more case ends 208, the one or more raised surfaces 514 may reduce an amount of fixturing required during manufacturing of the battery case 100 thereby improving the ease of manufacturing the battery case 100 and reducing costs.

In addition, the one or more raised surfaces 514 may reduce an amount of tooling (e.g., CNC machining) required to manufacture the one or more case ends 208. For example, the one or more case ends 208 may be manufactured almost entirely by casting with one or more features (e.g., the one or more raised surfaces 514 and/or a bottom surface of the one or more outer protrusions 228) being finished with additional tooling.

The one or more raised surfaces 514 may include a top (or first) raised surface 514a that is positioned on top of each of the one or more outer protrusions 228 as shown in FIG. 5. The top raised surface 514a may be configured to engage and/or deform the top portion 306 (marked in FIG. 3) of the wall 310. In examples, in addition or alternatively, the one or more raised surfaces 514 may include a bottom raised surface that is configured to engage and/or deform the bottom portion 308 of the wall 310.

The one or more raised surfaces 514 may further include one or more side raised surfaces positioned on a side (e.g., a left side or a right side) surface of each of the one or more outer protrusions 228. For example, the one or more raised surfaces 514 may include a first side raised surface 514b (e.g., positioned on a side surface of the top portion 520 of each of the one or more outer protrusions 228) and/or a second side raised surface 514c (e.g., positioned on a side surface of the bottom portion 522 of each of the one or more outer protrusions 228). The one or more side raised surfaces 514b and 514c may be configured to engage and/or deform a side portion of the wall 310. In examples, the one or more side raised surfaces may include one side raised surface (e.g., either the first side raised surface 514b or the second side raised surface 514c). In examples, the one or more raised surfaces 514 may include more than two side raised surfaces.

The one or more side raised surfaces 514b and 514c may both be positioned on one side of each of the one or more outer protrusions 228, with the opposite side being flat or substantially flat. This may help locate and/or align the one or more case sides 210 with the one or more case ends 208. Moreover, the cost of production of the one or more case ends 208 may be decreased by simplifying a casting mold for the one or more case ends 208 and/or decreasing an amount of tooling (e.g., CNC machining) required to produce the one or more case ends 208. The one or more side raised surfaces 514b and 514c may both be positioned on a side of each of the one or more outer protrusions 228 that faces away from the interior of the frame 202 and/or the battery case 100. In examples, each of the one or more outer protrusions 228 may include one or more side raised surfaces on both sides (e.g., the left side and the right side) of the one or more outer protrusions 228. The one or more side raised surfaces 514b and 514c may each include a hole (or threaded hole) 510 configured to receive a fastener (e.g., a pin, a screw, a bolt, etc.) 604 to couple and/or secure the one or more case sides 210 to the one or more outer protrusions 228.

The one or more raised surfaces 514 may further include a proximal raised surface 514d positioned at the proximal end 504 of each of the one or more outer protrusions 228. The proximal raised surface 514d may be configured to engage and/or deform the top portion 306 of the wall 310 and/or the side portion of the wall 310. As shown in FIG. 5, the proximal raised surface 514d may be positioned on the top portion 520 and the bottom portion 522 of each of the one or more outer protrusions 228.

The one or more raised surfaces 514 (e.g., the first side raised surface 514b and/or the second side raised surface 514c) may cause the one or more outer protrusions 228 to have a width H (marked in FIG. 6) that is greater than a width E (marked in FIG. 3) of the one or more cavities 302 (in examples the width H may be substantially the same as the width E). Moreover, the one or more raised surfaces 514 may cause the one or more outer protrusions 228 to have a height G (marked in FIG. 6) that is greater than a height F (marked in FIG. 3) of the one or more cavities 302 (in examples the height G may be substantially the same as the height F). The one or more outer protrusions 228 may have one or more undersized portions 606 positioned adjacent to the one or more raised surfaces 514. The one or more undersized portions 606 of the one or more outer protrusions 228 may have a width that is less than the width H. The combination of the one or more raised surfaces 514 and the one or more undersized portions 606 may increase the tolerance range for the dimensions of the one or more outer protrusions 228.

When the one or more outer protrusions 228 are inserted into a respective end (e.g., the left end 222a or the right end 222b) of the one or more case sides 210, the one or more fasteners (e.g., a pin, a screw, a bolt, etc.) 604 may be used to further couple and/or secure the one or more case sides 210 to the one or more case ends 208. In examples, sealant may be applied to the one or more outer protrusions 228 (e.g., on the proximal raised surface 514d) before the one or more outer protrusions 228 are inserted into the respective end to improve sealing of the battery case 100. In addition or alternatively, when the one or more outer protrusions 228 are inserted into a respective end (e.g., the left end 222a or the right end 222b) of the one or more case sides 210, the respective end may be welded to the one or more case ends 208 to further couple and/or secure the one or more case sides 210 to the one or more case ends 208.

FIGS. 7 and 8 illustrate example steps of coupling the one or more case ends 208 to the one or more case sides 210 and the one or more internal bars 212. Starting with FIG. 7, the one or more outer protrusions 228 may be inserted (e.g., by a user or a machine) into a respective end (e.g., the left end 222a or the right end 222b) of the one or more case sides 210. For example, the front outer protrusion 228a of the left case end 208a may be inserted into the left end 222a of the front case side 210a to locate and/or align the front case side 210a relative to or with the left case end 208a. The rear outer protrusion 228b of the left case end 208a may be inserted into the left end 222a of the rear case side 210b to locate and/or align the rear case side 210b relative to or with the left case end 208a. The front outer protrusion 228a of the right case end 208b may be inserted into the right end 222b of the front case side 210a to locate and/or align the front case side 210a relative to or with the right case end 208b. The rear outer protrusion 228b of the right case end 208b may be inserted into the right end 222b of the rear case side 210b to locate and/or align the rear case side 210b relative to or with the right case end 208b. In examples, sealant may be applied to the one or more outer protrusions 228 (e.g., on the proximal raised surface 514d) before the one or more outer protrusions 228 are inserted into the respective end to improve sealing of the battery case 100. In addition, the one or more inner protrusions 226 may be inserted (e.g., by a user or a machine) into a respective end of the one or more internal bars 212.

As shown in FIG. 8, the one or more case sides 210 (e.g., the left end 222a or the right end 222b) and/or the one or more internal bars 212 may be welded to the one or more case ends 208 to form the frame 202. For example, a plurality of joints formed between the one or more case ends 208 and the one or more case sides 210 may be welded. A first weld 800 may be positioned on an outer side (or first) surface 804 of the frame 202 and/or a second weld 802 may be positioned on a top (or second) surface 806 of the frame 202 (in examples, the top surface 806 may not include the second weld 802). The first weld 800 and the second weld 802 may reinforce and seal the battery case 100. Moreover, the locations of the first weld 800 and the second weld 802 may enable the bottom cover 204b to be flush with a bottom surface of the frame 202 as shown in FIG. 6. This may further improve the sealing of the battery case 100. In addition or alternatively, the one or more fasteners (e.g., a pin, a screw, a bolt, etc.) 604 (marked in FIG. 6) may be used to further couple and/or secure the one or more case sides 210 and/or the one or more internal bars 212 to the one or more case ends 208.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A waterproof case for sealing and protecting a vehicle battery, comprising:
a frame formed in the shape of a rectangle and defining a cavity for holding at least one vehicle battery, the frame including:
a plurality of side beams including a front side beam and a rear side beam, the plurality of side beams each having:
a left end and a right end, and
one or more cavities having a first width and a first height, and
a plurality of end beams each having a front end, a rear end, and a plurality of protrusions, the plurality of protrusions including:
a front protrusion having a greater width than the first width and a greater height than the first height, the front protrusion being configured to be inserted into the one or more cavities of the front side beam from the left end of the front side beam or the right end of the front side beam to align the front side beam with the plurality of end beams, and
a rear protrusion having a greater width than the first width and a greater height than the first height, the rear protrusion being configured to be inserted into the one or more cavities of the rear side beam from the left end of the rear side beam or the right end of the rear side beam to align the rear side beam with the plurality of end beams; and
a plurality of covers including a top cover and a bottom cover, the plurality of covers being configured to sandwich and seal the frame to prevent water from entering the cavity.

2. The waterproof case of claim 1, wherein the plurality of protrusions each further include a plurality of raised surfaces configured to engage and/or deform an inner surface of the plurality of side beams.

3. The waterproof case of claim 2, wherein the plurality of raised surfaces include at least one raised surface positioned on a top surface of the plurality of protrusions.

4. The waterproof case of claim 2, wherein the plurality of raised surfaces include at least one raised surface positioned on a side surface of the plurality of protrusions.

5. The waterproof case of claim 2, wherein:
the plurality of protrusions each further include a distal end and a proximal end; and
the plurality of raised surfaces include a proximal raised surface positioned at the proximal end.

6. The waterproof case of claim 2, wherein the plurality of protrusions each further include one or more undersized portions positioned adjacent to one or more of the plurality of raised surfaces, the one or more undersized portions having a width that is less than the first width.

7. The waterproof case of claim 2, wherein the plurality of protrusions each further include a distal end and a proximal end, the distal end being tapered.

8. The waterproof case of claim 1, wherein a plurality of joints formed between the plurality of side beams and the plurality of end beams are welded to seal the plurality of joints.

9. The waterproof case of claim 1, wherein the plurality of end beams are each formed by casting a first material.

10. The waterproof case of claim 9, wherein the plurality of side beams are each formed by extruding a second material.

11. A waterproof battery case for housing and protecting a vehicle battery, comprising:
a plurality of covers; and
a frame sandwiched between the plurality of covers and defining a cavity for holding at least one vehicle battery, the frame including:
a plurality of extruded case sides each having a wall defining one or more cavities, and
a plurality of cast case ends configured to couple to the plurality of extruded case sides, the plurality of cast case ends each having a plurality of protrusions configured to:
be inserted into the one or more cavities, and
swell and/or deform the wall to align the plurality of extruded case sides relative to the plurality of cast case ends when the plurality of protrusions are inserted into the one or more cavities.

12. The waterproof battery case of claim 11, wherein the plurality of protrusions each include one or more raised surfaces configured to swell and/or deform the wall.

13. The waterproof battery case of claim 12, wherein the one or more raised surfaces include at least one raised surface positioned on a top surface of the plurality of protrusions.

14. The waterproof battery case of claim 12, wherein the one or more raised surfaces include at least one raised surface positioned on a side surface of the plurality of protrusions.

15. The waterproof battery case of claim 12, wherein:
the plurality of protrusions each further include a distal end and a proximal end; and
the one or more raised surfaces include a proximal raised surface positioned at the proximal end.

16. The waterproof battery case of claim 12, wherein the one or more raised surfaces cause the plurality of protrusions to have a width that is greater than a width of the one or more cavities.

17. The waterproof battery case of claim 12, wherein the one or more raised surfaces cause the plurality of protrusions to have a height that is greater than a height of the one or more cavities.

18. The waterproof battery case of claim 11, wherein:
the plurality of cast case ends each further have a first end and a second end opposite the first end; and
the plurality of protrusions include:
a first protrusion positioned at the first end of each of the plurality of cast case ends, and
a second protrusion positioned at the second end of each of the plurality of cast case ends.

19. The waterproof battery case of claim 11, wherein a plurality of joints formed between the plurality of extruded case sides and the plurality of cast case ends are welded to seal the plurality of joints.

20. The waterproof battery case of claim 11, wherein:
the plurality of extruded case sides include two extruded case sides; and
the plurality of cast case ends include two cast case ends.
